(19) United States
(12) Patent Application Publication
(10) Pub. No.: US 2024/0049072 A1
(43) Pub. Date: Feb. 8, 2024

(54) METHOD AND APPARATUS FOR HANDLING GROUP MOBILITY OF MOBILE INTEGRATED ACCESS AND BACKHAUL NODE CELL IN A WIRELESS COMMUNICATION SYSTEM

(71) Applicant: Samsung Electronics Co., Ltd., Gyeonggi-do (KR)

(72) Inventor: June HWANG, Gyeonggi-do (KR)

(21) Appl. No.: 18/364,252

(22) Filed: Aug. 2, 2023

(30) Foreign Application Priority Data
Aug. 3, 2022 (KR) 10-2022-0096710
Nov. 3, 2022 (KR) 10-2022-0145568

(51) Int. Cl. H04W 36/00; H04W 36/08

(52) U.S. Cl. CPC H04W 36/0072; H04W 36/08

(57) ABSTRACT

The disclosure relates to a fifth generation (5G) or sixth generation (6G) communication system for supporting a higher data transmission rate. Disclosed is a method performed by a mobile integrated access backhaul (IAB) node in a wireless communication system, including receiving, from a target donor node via a source donor node, a first radio resource control (RRC) message for a migration of the mobile IAB node, receiving, from the target donor node via the source donor node, a second RRC message for a handover of at least one user equipment (UE) connected with a first cell, performing the migration with the target donor node based on the first RRC message, and, transmitting, to the at least one UE on a second cell different from the first cell, the second RRC message.

### CROSS-REFERENCE TO RELATED APPLICATION(S)

This application is based on and claims priority under 35 U.S.C. § 119 to Korean Patent Application Nos. 10-2022-0096710 and 10-2022-0145568, filed on Aug. 3, 2022, and Nov. 3, 2022, respectively, in the Korean Intellectual Property Office, the disclosures of which are incorporated herein by reference in their entireties.

### BACKGROUND

### 1. Field

The disclosure relates generally to an operation of a terminal in a wireless communication system, and more particularly, to a method and apparatus for handling a cell change of the terminal in regard to an integrated access and backhaul (IAB) node in the wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (Bandwidth Part), new channel coding methods such as an LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Since the development of the wireless communication system makes it possible to provide various services as described above, there is a need for a method for effectively providing the services.

### SUMMARY

The disclosure has been made to address at least the above-mentioned problems and/or disadvantages and to provide at least the advantages described below.

Accordingly, an aspect of the disclosure is to provide a method and apparatus capable of effectively handling a cell change of a terminal, caused by a donor node change when an TAB node moves in a wireless communication system.

Another aspect of the disclosure is to provide a method and apparatus by which a difference between the timing at which a target donor node performs an admission control of terminals and the timing at which the terminal applies a given configuration of a target cell may be determined.

In accordance with an aspect of the disclosure, a method performed by a mobile integrated access backhaul (IAB) node in a wireless communication system includes receiving, from a target donor node via a source donor node, a first radio resource control (RRC) message for a migration of the mobile IAB node, receiving, from the target donor node via the source donor node, a second RRC message for a handover of at least one user equipment (UE) connected with a first cell, performing the migration with the target donor node based on the first RRC message, and transmitting, to the at least one UE on a second cell different from the first cell, the second RRC message.

### BRIEF DESCRIPTION OF THE DRAWINGS

The above and other aspects, features and advantages of certain embodiment of the disclosure will be more apparent from the following detailed description, taken in conjunction with the accompanying drawings, in which:

FIG. 1 illustrates a structure of a long term evolution (LTE) system according to an embodiment;

FIG. 2 illustrates a radio protocol structure in an LTE system according to an embodiment;

FIG. 3 illustrates a structure of a next-generation mobile communication system according to an embodiment;

FIG. 4 illustrates a radio protocol structure of a next-generation mobile communication system according to an embodiment;

FIG. 5 is a block diagram illustrating a structure of a UE according to an embodiment;

FIG. 6 is a block diagram illustrating a structure of an NR gNode B (gNB) according to an embodiment;

FIG. 7 illustrates an operation of cell generation and cell access of a UE depending on a movement of a mobile IAB node according to an embodiment;

FIG. 8 illustrates an operation in which a mobile IAB node stores a handover command of a UE and, after a new cell operates, delivers a handover command to a UE according to an embodiment;

FIG. 9 illustrates an operation of performing a handover of a UE when a target donor is able to store a handover (HO) command message of an access UE according to an embodiment; and

FIG. 10 illustrates an operation of performing a handover of a UE when a conditional handover is applied to an access UE according to an embodiment.

### DETAILED DESCRIPTION

Hereinafter, embodiments of the disclosure are described in detail with reference to the accompanying drawings.

In describing the embodiments, technical contents well known in the technical field to which the disclosure pertains and which are not directly related to the disclosure will be omitted for the sake of clarity and conciseness.

The terms used herein are defined according to the functions of the disclosure. Thus, the terms may vary depending on a user's or operator's intention and usage and may be understood based on the descriptions made herein.

In the following description, terms for identifying an access node and terms referring to network entities, messages, an interface between network entities, and various pieces of identification information are described for convenience of explanation. Therefore, the disclosure is not limited to the terms described below, and other terms having equivalent technical meanings may also be used.

Herein, a component is expressed in a singular or plural form according to the specific embodiment. However, the singular or plural expression is selected properly for convenience of explanation, and thus the embodiments of the disclosure are not limited to a single or a plurality of components. Therefore, a component expressed in a plural form may also be expressed in a singular form, or vice versa.

Hereinafter, a base station is an entity which performs resource allocation of a terminal, and may be at least one of a gNode B, an eNode B, a node B, a base station (BS), a radio access unit, a base station controller, and a node on a network. The terminal may include a UE, a mobile station (MS), a cellular phone, a smart phone, a computer, or a multimedia system capable of performing a communication function. Herein, a downlink (DL) refers to a wireless transmission path of a signal transmitted by the base station to the terminal, and an uplink (UL) refers to a wireless transmission path of a signal transmitted by the terminal to the base station. In addition, although an LTE or LTE-advanced (LTE-A) system may be described hereinafter for example, the disclosure is also applicable to another communication system having a similar technical background and channel format. For example, a 5G NR mobile communication technology developed after LTE-A may be included in a system to which the disclosure is applicable, wherein 5G includes the existing LTE and LTE-A and other similar services. In addition, the disclosure is applicable to other communication systems through some modifications within a range not significantly departing from the scope of the disclosure under the decision of those skilled in the art.

The term “unit” as used herein indicates software or a hardware component such as a field programmable gate array (FPGA) or an application-specific integrated circuit (ASIC), and unit performs specific roles. However, unit is not limited to software or hardware. unit may be configured to reside on an addressable storage medium and configured to reproduce on one or more processors. Accordingly, unit may include components such as software, object-oriented software, class and task components, processes, functions, attributes, procedures, sub-routines, segments of program code, drivers, firmware, microcode, circuitry, data, databases, data structures, tables, arrays, and variables. The functionalities provided in the components and unit may be combined to fewer components and units or may be further separated into additional components and units. The components and units may be implemented to reproduce one or more central processing units (CPUs) within a device or a security multimedia card. A unit may include one or more processors.

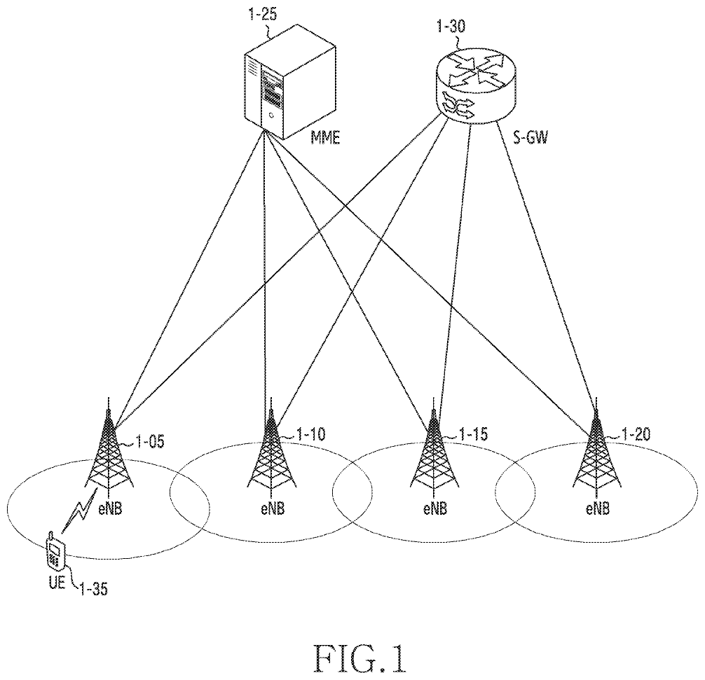

FIG. 1 illustrates a structure of an LTE system according to an embodiment.

Referring to FIG. 1, a radio access network of the LTE system may include next-generation base stations 1-05, 1-10, 1-15, and 1-20, a mobility management entity (MME) 1-25, and a serving-gateway (S-GW) 1-30. A UE 1-35 may have access to an external network via the eNBs 1-05 to 1-20 and the S-GW 1-30.

In FIG. 1, the eNBs 1-05 to 1-20 may correspond to the existing node B of a universal mobile telecommunication system (UMTS) system. The eNB may be coupled to the UE 1-35 through a radio channel and may perform a more complex role than the existing node B. In the LTE system, all user traffic including a real-time service such as voice over IP (VoIP) through an Internet protocol may be served through a shared channel. Therefore, the eNBs 1-05 to 1-20 may perform scheduling by collecting state information of UEs such as a buffer state, an available transmit power state, and a channel state. One eNB may control a plurality of cells. For example, in order to implement a transmission rate of 100 megabits per second (Mbps), the LTE system may use an orthogonal frequency division multiplexing (OFDM) as a radio access technology in a bandwidth of 20 megahertz (MHz) but the disclosure is not limited to the example above. In addition, the eNBs 1-05 and 1-20 may apply an adaptive modulation & coding (AMC) scheme which determines a modulation scheme and a channel coding rate in accordance with the channel state of the UE. The S-GW 1-30 provides a data bearer and may create or remove the data bearer under the control of the MME 1-25. The MME is in charge of various control functions as well as a mobility management function for the UE, and may be coupled to a plurality of base stations.

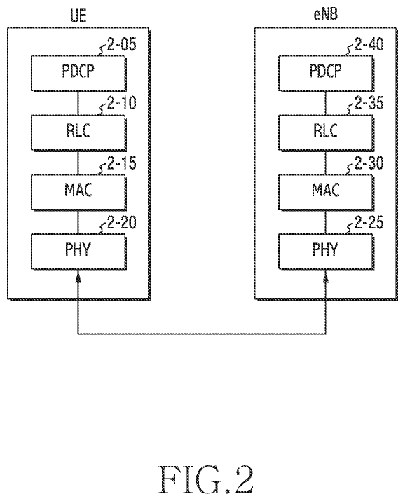

FIG. 2 illustrates a radio protocol structure in an LTE system according to an embodiment.

Referring to FIG. 2, a radio protocol of the LTE system may include packet data convergence protocol (PDCP) layers 2-05 and 2-40, radio link control (RLC) layers 2-10 and 2-35, medium access control (MAC) layers 2-15 and 2-30, and physical (PHY) layers 2-20 and 2-25 respectively in a UE and an eNB. The radio protocol of the LTE system may include fewer or more layers than those in the structure of FIG. 2.

The PDCP layers 2-05 and 2-40 may be in charge of an IP header compression/restoration operation. A main function of the PDCP layers 2-05 and 2-40 may be summarized as follows but the disclosure is not limited thereto.
Header compression and decompression function (robust header compression (ROHC) only)
User data transfer function for transfer of user data
In-sequence delivery function for in-sequence delivery of upper layer packet data units (PDUs) at a PDCP re-establishment procedure for an RLC acknowledge mode (AM)
Reordering function for split bearers in DC (only support for RLC AM): PDCP PDU routing for transmission and PDCP PDU reordering for reception
Duplication detection function For duplicate detection of lower layer SDUs at a PDCP re-establishment procedure for RLC AM
Retransmission function for retransmission of PDCP SDUs at handover and, for split bearers in DC, of PDCP PDUs at a PDCP data-recovery procedure for RLC AM
Ciphering and deciphering function
Timer-based SDU discarding function in UL

The RLC layers 2-10 and 2-35 may perform an automatic repeated request (ARQ) operation by reconfiguring a PDCP PDU with a proper size. A main function of the RLC layer may be summarized as follows but the disclosure is not limited thereto.
Data transfer function for transfer of upper layer PDUs
ARQ function for error correction through ARQ (only for AM data transfer)
Concatenation, segmentation, and reassembly function of RLC SDUs (only for UM and AM data transfer)
Re-segmentation function for re-segmentation of RLC data PDUs (only for AM data transfer)
Reordering function for reordering of RLC data PDUs (only for UM and AM data transfer)
Duplication detection function (only for UM and AM data transfer)
Error detection function for protocol error detection (only for AM data transfer)
RLC SDU discarding function (only for UM and AM data transfer)
RLC re-establishment function

The MAC layers 2-15 and 2-30 may be coupled to several RLC layer devices configured in one UE, and may perform an operation of multiplexing RLC protocol data units (PDUs) to a MAC PDU and demultiplexing the RLC PDUs from the MAC PDU. A main function of the MAC layers 2-15 and 2-30 may be summarized as follows but the disclosure is not limited thereto.
Mapping function for mapping between logical channels and transport channels
Multiplexing and demultiplexing function of MAC SDUs belonging to one or different logical channels into/from transport blocks (TBs) delivered to/from the physical layer on transport channels
Scheduling information reporting function
Hybrid Automatic Repeat and reQuest (HARQ) function for error correction through HARQ
Priority handling function between logical channels of one UE
Priority handling function between UEs by means of dynamic scheduling
Multimedia Broadcast and Multicast Service (MBMS) service identification function
Transport format selection function
Padding function

The PHY layers 2-20 and 2-25 may perform an operation in which channel coding and modulation are performed on higher layer data. Thus, an OFDM symbol is created and transmitted through a radio channel or in which demodulation and channel coding are performed on the OFDM symbol received through the radio channel and then is delivered to a higher layer.

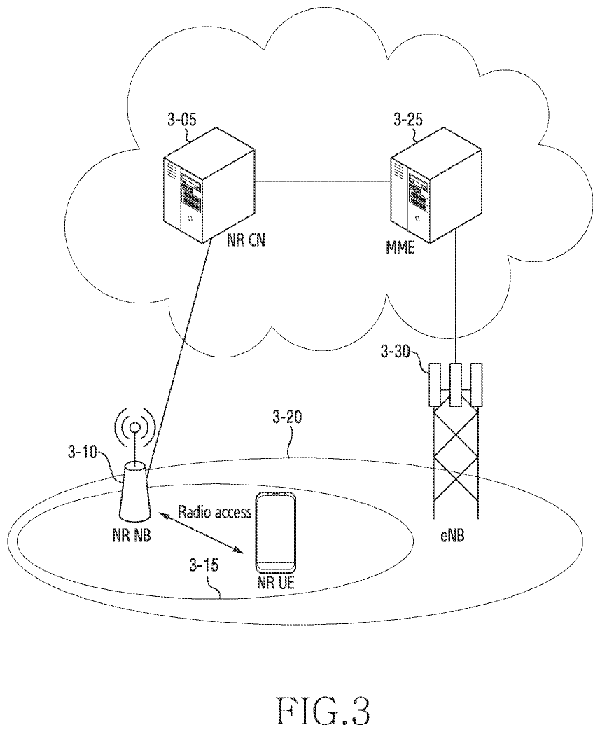

FIG. 3 illustrates a structure of a next-generation mobile communication system according to an embodiment.

Referring to FIG. 3, a radio access network of a wireless communication system (hereinafter, NR or 5G) may include an NR node B 3-10 and an NR core network (CN) 3-05. An NR UE 3-15 may have access to an external network via the NR gNB 3-10 and the NR CN 3-05.

In FIG. 3, the NR gNB 3-10 may correspond to an eNB of the existing LTE system. The NR gNB may be coupled to the NR UE 3-15 through a radio channel and may provide better service than the existing node B. In the next-generation mobile communication system, all user traffic may be served through a shared channel. Therefore, the NR NB 3-10 may perform scheduling by collecting state information of UEs, such as a buffer state, an available transmission power state, and a channel state. One NR gNB may control a plurality of cells.

A typical maximum bandwidth or higher may be applied in the next-generation mobile communication system to implement ultra-high speed data transmission compared to normal LTE. In addition, a beamforming technology may be additionally used by using OFDM as a radio access technology.

The NR gNB may apply an AMC scheme which determines a modulation scheme and a channel coding rate in accordance with a channel state of a UE. The NR CN 3-05 may perform a function such as mobility support, bearer setup, and quality of service (QoS) setup. The NR CN 3-05 is in charge of various control functions in addition to a mobility management function for the UE, and may be coupled to a plurality of base stations. The next-generation mobile communication system may also interwork with the LTE system, and the NR CN 3-05 may be coupled to the MME 3-25 via a network interface. The MME may be coupled to an eNB 3-30 which is an LTE base station.

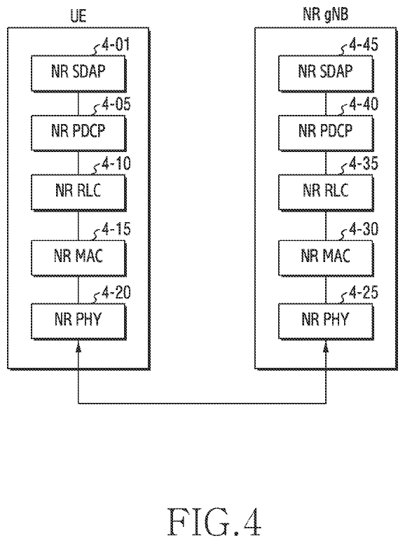

FIG. 4 illustrates a radio protocol structure of a next-generation mobile communication system according to an embodiment.

Referring to FIG. 4, in a radio protocol of the next-generation mobile communication system, a UE and an NR gNB may respectively include NR service data adaptive protocol (SDAP) layer devices 4-01 and 4-45, NR PDCP layer devices 4-05 and 4-40, NR RLC layer devices 4-10 and 4-35, NR MAC layer devices 4-15 and 4-30, and NR PHY layer devices 4-20 and 4-25 (hereinafter, layers and layer devices are interchangeably used). The radio protocol of the next-generation mobile communication system may include fewer or more layers than those in the structure of FIG. 4.

A main function of the NR SDAP layer devices 4-01 and 4-45 may include some of the following functions but the disclosure is not limited thereto.
User data transfer function for transfer of user plane data
QoS flow and data bearer mapping function for UL and DL mapping between a QoS flow and a data radio bearer (DRB)
QoS flow ID marking function for marking QoS flow ID in both UL and DL packets
Function of mapping reflective QoS flow to DRB for UL SDAP PDUs

For an SDAP layer device, the UE may be configured, through an RRC message, as to whether to use a header of the SDAP layer devices 4-10 and 4-45 or to use a function of the SDAP layer devices 4-01 and 4-45 for each PDCP layer device or for each bearer or logical channel. In addition, when the SDAP layer devices 4-01 and 4-45 have SDAP headers configured thereto, the UE may be instructed to update or reconfigure mapping information for a QoS flow and data bearer for a UL and a DL by using a non-access stratum (NAS) reflective QoS setup 1-bit indicator of the SDAP header and an AS reflective QoS setup 1-bit indicator. The SDAP header may include QoS flow ID information indicating QoS. The QoS information may also be used as data processing priority, scheduling information, or the like to smoothly support services.

A main function of the NR PDCP layer devices 4-05 and 4-40 may include the following functions but the disclosure is not limited thereto.
Header compression and decompression function-ROHC only
User data transfer function
In-sequence delivery function upper layer PDUs
Out-of-sequence delivery function of upper layer PDUs
Reordering function (PDCP PDU reordering for reception)
Duplication detection function of lower layer SDUs
Retransmission function of PDCP SDUs
Ciphering and deciphering function
Timer-based SDU discarding function in UL

The reordering of the NR PDCP layer devices 4-05 and 4-40 may indicate sequentially reordering PDCP PDUs received from a lower layer based on a PDCP sequence number (SN) and may include at least one of a function of delivering data to a higher layer in a reordered sequence, directly delivering the data without considering the order, recording lost PDCP PDUs through reordering, reporting a state for the lost PDCP PDUs to a transmitting side, and requesting for transmission of the lost PDCP PDUs.

A main function of the NR RLC layer devices 4-10 and 4-35 may include the following functions but the disclosure is not limited thereto.
Data transfer function for transfer of upper layer PDUs
In-sequence delivery function for in-sequence delivery of upper layer PDUs
Out-of-sequence delivery function for out-of-sequence delivery of upper layer PDUs
ARQ function for error correction
Concatenation, segmentation, and reassembly function of RLC SDUs
Re-segmentation function for re-segmentation of RLC data PDUs
Reordering function for reordering of RLC data PDUs
Duplication detection function
Error detection function for protocol error detection
RLC SDU discarding function
RLC re-establishment function

The in-sequence delivery function of the NR RLC layer devices 4-10 and 4-35 may indicate a function of sequentially delivering RLC SDUs received from a lower layer to a higher layer and may include a function in which, when one RLC SDU is originally received by being segmented into several RLC SDUs, the RLC SDUs are reassembled and delivered.

The in-sequence delivery function of the NR RLC layer devices 4-10 and 4-35 may include a function of reordering the received RLC PDUs according to an RLC SN or a PDCP SN. The in-sequence delivery function of the NR RLC layer devices 4-10 and 4-35 may include at least one of a function of recording lost RLC PDUs through reordering, transmitting a state for the lost PDCP PDUs to a transmitting side, and requesting for retransmission of the lost PDCP PDUs.

The in-sequence delivery function of the NR RLC layer devices 4-10 and 4-35 may include a function in which, when there is a lost RLC SDU, only RLC SDUs ahead of the lost RLC SDU are delivered sequentially to a higher layer.

The in-sequence delivery function of the NR RLC layer devices 4-10 and 4-35 may include a function in which, when a specific timer expires even if the lost RLC SDU exists, all RLC SDUs received before the timer starts are delivered sequentially to the higher layer.

The in-sequence delivery function of the NR RLC layer devices 4-10 and 4-35 may include a function in which, when the specific timer expires even if the lost RLC SDU exists, all RLC SDUs received up to the present time are delivered sequentially to the higher layer.

The NR RLC layer devices 4-10 and 4-35 may handle the RLC PDUs in the order by which the RLC PDUs are received irrespective of the order of sequence numbers out-of-sequence delivery and deliver the RLC PDUs to the NR PDCP layer devices 4-05 and 4-40.

Upon receiving a segment, the NR RLC layer devices 4-10 and 4-35 may receive segments stored in a buffer or to be received at a later time and reconstruct the segments into one complete RLC PDU and then deliver the RLC PDU to the NR PDCP layer devices 4-05 and 4-40.

The NR RLC layers 4-10 and 4-35 may not include a concatenation function. In this case, the function may be performed in the NR MAC layers 4-15 and 4-30 or may be replaced with a multiplexing function of the NR MAC layers 4-15 and 4-30.

The out-of-sequence delivery function of the NR RLC layer devices 4-10 and 4-35 may include a function of delivering RLC SDUs received from a lower layer to a higher layer irrespective of the order. The out-of-sequence delivery function of the NR RLC layer devices 4-10 and 4-35 may include a function in which, when one RLC SDU is originally received by being segmented into several RLC SDUs, the RLC SDUs are reassembled and delivered, and a function of recording lost RLC PDUs by storing and ordering an RLC SN or PDCP SN of the received RLC PDUs.

The NR MAC layer devices 4-15 and 4-30 may be coupled to several RLC layer devices constructed in one UE, and a main function of the NR MAC layer devices 4-15 and 4-30 may include some of the following functions.
Mapping function between logical channels and transport channels
Multiplexing and demultiplexing function of MAC SDUs
Scheduling information reporting function
HARQ function for error correction through HARQ
Priority handling function between logical channels of one UE
Priority handling function between UEs by means of dynamic scheduling
MBMS identification function
Transport format selection function
Padding function

The NR PHY layer devices 4-20 and 4-25 may perform channel coding and modulation on higher layer data and may perform an operation in which an OFDM symbol is created and transmitted through a radio channel or in which demodulation and channel coding are performed on the OFDM symbol received through the radio channel and then are delivered to a higher layer (e.g., NR MAC layer devices 4-15 and 4-30, NR RLC layer devices 4-10 and 4-35, NR PDCP layer devices 4-05 and 4-40, and NR SDAP layer devices 4-01 and 4-45).

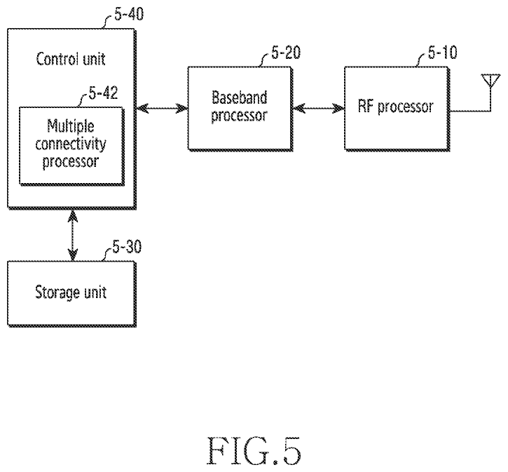

FIG. 5 is a block diagram illustrating a structure of a UE according to an embodiment.

Referring to FIG. 5, the UE may include an RF processor 5-10, a baseband processor 5-20, a storage unit 5-30, and a control unit 5-40, but the UE may include fewer or more components than the components of FIG. 5.

The RF processor 5-10 may perform a function for transmitting and receiving a signal via a radio channel, such as signal band conversion or amplification, may up-convert a baseband signal into an RF signal provided from the baseband processor 5-20, may transmit the signal through an antenna, and may down-convert an RF signal received through the antenna into a baseband signal. For example, the RF processor 5-10 may include a transmission filter, a reception filter, an amplifier, a mixer, an oscillator, a digital to analog convertor (DAC), and an analog to digital convertor (ADC), but the disclosure is not limited thereto. Although only one antenna is illustrated in FIG. 5, a UE may have a plurality of antennas. The RF processor 5-10 may include a plurality of RF chains and may perform beamforming. For the beamforming, the RF processor 5-10 may adjust a phase and magnitude of each of signals transmitted and received through a plurality of antennas or antenna elements. The RF processor 5-10 may perform a MIMO operation and may receive several layers when performing the MIMO operation. The RF processor 5-10 may properly configure the plurality of antennas or the antennal elements under the control of the control unit to sweep a beam to be received, or may adjust a beam width and a direction of the beam to be received and a beam that has been received so that the beam to be received is associated with a beam to be transmitted.

The baseband processor 5-20 may perform a conversion function between a baseband signal and a bit-stream according to a physical layer protocol of the system. For example, in data transmission, the baseband processor 5-20 may generate complex symbols by coding and modulating a transmission bit-stream. In data reception, the baseband processor 5-20 may restore a reception bit-stream by demodulating and decoding a baseband signal provided from the RF processor 5-10. For example, in case of conforming to an OFDM scheme, in data transmission, the baseband processor 5-20 may generate complex symbols by performing coding and modulation on a transmitted bit-stream, map the complex symbols to subcarriers, and then configure OFDM symbols by performing an inverse fast Fourier transform (IFFT) operation and a cyclic prefix (CP) insertion operation. In data reception, the baseband processor 5-20 may split the baseband signal provided from the RF processor 5-10 on an OFDM symbol basis, restore signals mapped to the subcarriers by using a fast Fourier transform (FFT) operation, and then restore a received bit-stream by performing demodulation and decoding.

The baseband processor 5-20 and the RF processor 5-10 transmit and receive a signal as described above and may be referred to as a transmitter, a receiver, a transceiver, or a communication unit. At least one of the baseband processor 5-20 and the RF processor 5-10 may include a plurality of communication modules to support a plurality of different radio access technologies and may include different communication modules to process signals of different frequency bands. For example, the different radio access technologies may include a wireless local area network (LAN), a cellular network (e.g., LTE), etc. The different frequency bands may include a super high frequency (SHF) (e.g., 2.5 GHz, 5 GHz) band and an mmWave (e.g., 60 GHz) band. The UE may transmit and receive a signal with respect to the gNB by using the baseband processor 5-20 and the RF processor 5-10, and the signal may include control information and data.

The storage unit 5-30 may store data such as a basic program, an application program, and setup information, for an operation of the UE. In particular, the storage unit 5-30 may store information related to a second access node which performs wireless communication by using a second radio access technology. The storage unit 5-30 may provide stored data at the request of the control unit 5-40 and may be constructed of a plurality of memories. Alternatively, the storage unit 5-30 may store a program for performing a method of allocating an IP address in an IAB system described herein. The control unit 5-30 may further include a multiple connectivity processor 5-43.

The control unit 5-40 controls overall operations of the UE. For example, the control unit 5-40 may transmit and receive a signal via the baseband processor 5-20 and the RF processor 5-10, may write data to the storage unit 5-40, and may read the data. For this, the control unit 5-40 may include at least one processor such as a communication processor which provides control for communication and an application processor (AP) which provides control to a higher layer such as an application program.

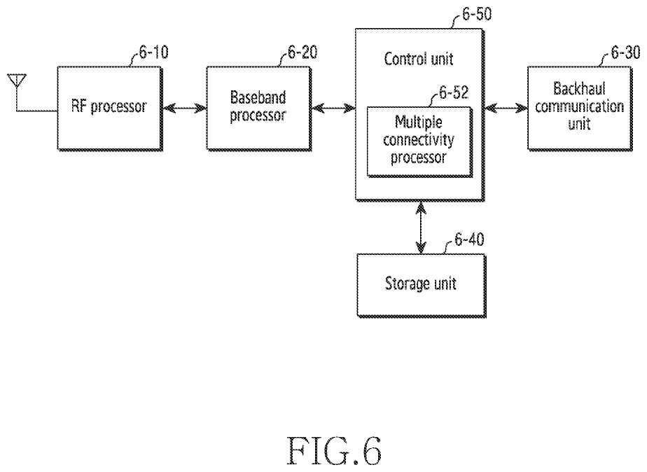

FIG. 6 is a block diagram illustrating a structure of an NR gNB according to an embodiment. The control unit 6-50 may further include a multiple connectivity processor 6-52. A network entity (or a network function) and an IAB node may have structures identical or similar to that of the NR gNB of FIG. 6.

Referring to FIG. 6, the gNB may include an RF processor 6-10, a baseband processor 6-20, a backhaul communication unit 6-30, a storage unit 6-40, and a control unit 6-50. However, the gNB may include fewer or more components than those in the structure of FIG. 6.

The RF processor 6-10 may perform a function for transmitting and receiving a signal via a radio channel, such as signal band conversion and amplification, may up-convert a baseband signal into an RF signal provided from the baseband processor 6-20 and then transmit the signal through an antenna, and may down-convert an RF signal received through the antenna into a baseband signal. For example, the RF processor 6-10 may include a transmission filter, a reception filter, an amplifier, a mixer, an oscillator, a DAC, an ADC, or the like. Although only one antenna is illustrated in FIG. 6, a first access node may have a plurality of antennas. The RF processor 6-10 may include a plurality of RF chains and may perform beamforming. For the beamforming, the RF processor 6-10 may adjust a phase and magnitude of each of signals transmitted and received through a plurality of antennas or antenna elements. The RF processor may perform a DL MIMO operation by transmitting at least one layer.

The baseband processor 6-20 may perform a conversion function between a baseband signal and a bit-stream according to a physical layer protocol of a first radio access technology. For example, in data transmission, the baseband processor 6-20 may generate complex symbols by coding and modulating a transmission bit-stream. In data reception, the baseband processor 6-20 may restore a reception bit-stream by demodulating and decoding a baseband signal provided from the RF processor 6-10. For example, in case of conforming to an OFDM scheme, in data transmission, the baseband processor 6-20 may generate complex symbols by performing coding and modulation on a transmitted bit-stream, map the complex symbols to subcarriers, and then configure OFDM symbols by performing an IFFT operation and a CP insertion operation. In data reception, the baseband processor 6-20 splits the baseband signal provided from the RF processor 6-10 on an OFDM symbol basis, restores signals mapped to the subcarriers by using an FFT operation, and then restores a received bit-stream by performing demodulation and decoding. The baseband processor 6-20 and the RF processor 6-10 may transmit and receive a signal as described above and may be referred to as a transmitter, a receiver, a transceiver, or a communication unit.

The backhaul communication unit 6-30 may provide an interface for performing communication with other nodes in the network. That is, the backhaul communication unit 6-30 may convert a bitstream transmitted from a main gNB to an auxiliary gNB or a core network, into a physical signal, and may convert the physical signal received from another node into a bitstream.

The storage unit 6-40 may store data such as a basic program, an application program, setup information, or the like for an operation of the main gNB. In particular, the storage unit 6-40 may store information on a bearer assigned to an accessed UE, a measurement result reported from the accessed UE, or the like. The storage unit 6-40 may provide multiple connectivity to the UE or may store information used as a criterion for determining whether to provide or stop multiple connectivity to the UE. The storage unit 6-40 may provide the stored data at the request of the control unit 6-50 and may be constructed of a storage medium such as a read only memory (ROM), a random access memory (RAM), a hard disk, a compact disc (CD)-ROM, and a digital versatile disc (DVD), or a combination of storage media. The storage unit 6-40 may be constructed of a plurality of memories and may store a program for performing a method of allocating an IP address in an IAB system described herein.

The control unit 6-50 may control overall operations of the gNB. For example, the control unit 6-50 may transmit and receive a signal via the baseband processor 6-20 and the RF processor 6-10 or via the backhaul communication unit 6-30. The control unit 6-50 may write data to the storage unit 6-40 and read the data. For this, the control unit 6-50 may include at least one processor. In addition, at least one component in the gNB may operate to perform the embodiments described herein.

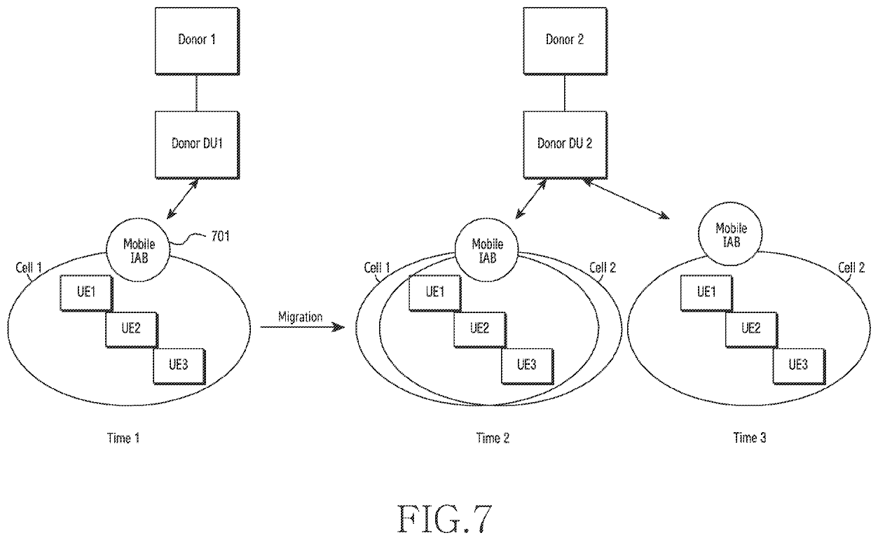

FIG. 7 illustrates an operation of cell generation and cell access of a UE depending on a movement of a mobile IAB node according to an embodiment.

Referring to FIG. 7, the mobile IAB node 701 may access a donor 1 as a source donor. A parent node or a donor DU 1 may be controlled by the donor 1. The mobile IAB node 701 operates a cell 1 through a distributed unit (DU) of the mobile IAB node 701, and UEs (i.e., UEs 1 to 3) may exchange data with a network through cell 1. In this situation, when the mobile IAB node 701 moves to access an area of a cell operated by a donor DU 2 controlled by a donor 2, the mobile IAB node 701 may receive a handover command from the donor 1. According to the handover command, the mobile IAB node 701 may move a control plane and user plane of a mobile termination of the mobile IAB node 701 and F1 context of a DU of the mobile IAB node 701 to a new donor 2 and then initiate a cell 2 through a new cell operation indication received from donor 2. After cell 2 operates, the UEs (the UEs 1 to 3) may perform a handover from cell 1 to cell 2. When the handover to cell 2 of all UEs is complete after a specific time, the donor 2 may instruct the mobile IAB node to end the operation of cell 1. Alternatively, specific time information may be given to the handover command of the mobile IAB node to maintain cell 1 for a corresponding time duration.

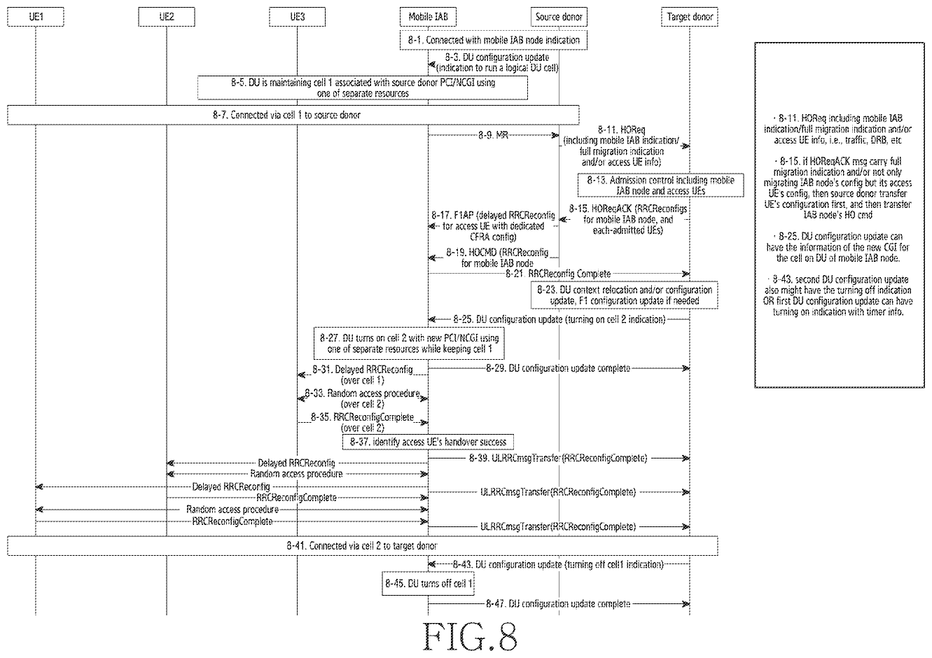

FIG. 8 illustrates an operation in which a mobile IAB node stores a handover command of a UE and, after a new cell operates, delivers a handover command to a UE according to an embodiment.

Referring to FIG. 8, in step 8-1, in a connected mode, the mobile IAB node may notify a donor node that it is the mobile IAB node, which is recognized by the donor node.

In step 8-3, the donor node which has recognized that it is the mobile IAB node may instruct a co-located DU of the mobile IAB node to operate a cell through a logical DU. Physical cell identification (PCI) and/or NR cell global identifier (NCGI) information associated with a source node which is a current donor may be delivered together with this instruction as a message on an F1 interface. An indicator regarding whether to use a hard split physical resource or a shared physical resource when operating a corresponding cell may also be included.

In step 8-5, the mobile IAB node may start to operate a cell which broadcasts a PCI/NCGI of the source donor by considering corresponding logical DU operation information. In this case, when it is instructed to use the hard split physical resource or there is no instruction in step 8-3, the cell may operate by using the hard split physical resource.

In step 8-7, it may be assumed that UEs 1 to 3 are handed over or perform an initial access, after cell 1 is initiated.

In step 8-9, a measurement report (MR) configured for the mobile IAB node may be produced at a specific timing and be reported to the source donor.

In step 8-11, the source donor may determine a handover to a target donor, based on the measurement report result. The source donor may send a HandoverRequest message (hereinafter, an HOReq message) to the target donor. The HOReq message may include an indicator of a mobile IAB node and/or an indicator indicating full migration. As context information of a migration IAB node, the HOReq message may include RRC configuration information of an MT currently operating, DU configuration information, information on the number of data radio bearers (DRB)s/e-utran radio access bearers (ERAB)s/backhaul (BH) RLC CHs to be operated, id (identification) information of each BH RLC CH, and/or information on the number of DRB s/ERABs/BH RLC CHs desired to operate in the target donor. As UE context of UEs currently accessing the migration IAB node, the HOReq message may include RRC configuration information currently operating, DRB/ERAB information, and information on the number of DRB s/ERABs desired to operate in a target. In case of an access UE, an indicator indicating that it is an access UE of the mobile IAB node may be included. The PCI and/or the NCGI, and factor information of the currently operating cell, including whether the hard split resource is used or whether the shared resource is used, may be included in information of the DU.

In step 8-13, upon receiving the HOReq message of step 8-11, the target node may perform an admission control, and may create configuration information to be used in a target cell to be used by a corresponding admitted IAB node, i.e., a cell operated by a parent node or donor DU controlled by a target donor node. An admitted access UE may create configuration information to be used in a target cell (cell 2) being operated by the target donor.

In step 8-15, the target donor may deliver a handoverRequestACK to the source donor. This message may include configuration information of the target cell of the admitted IAB node and/or configuration information in the target cell (the cell 2) of the admitted access UE, created in step 8-13, and may include an indicator indicating for each access UE that it is an access UE, and/or an indicator indicating for the admitted IAB node that each entity is an IAB node.

In step 8-17, the source node may deliver the configuration information for the access UE, received in step 8-15, i.e., RRCReconfiguration messages to the mobile IAB node. In this case, an F1-AP message may be used. A delayed RRCReconfiguration indicator may be included in this message for each UE. When the mobile IAB node receives the message having the delayed RRCReconfiguration indicator included therein, a corresponding RRCReconfiguration message may be stored in the mobile IAB node for each UE until a specific condition is satisfied. The stored RRCReconfiguration may be delivered to the UE.

In step 8-19, the source node may deliver the configuration information (handover command), received in step 8-15, to be used in the target cell for the mobile IAB node, i.e., a migration IAB node, to the mobile IAB node through an F1-AP message. Upon receiving this message, the mobile IAB node may perform a handover.

However, there may be no set order for steps 8-17 and 8-19.

In step 8-21, the mobile IAB node may apply the received configuration information of the handover command while performing the handover, and optionally, may transmit an RRCReconfigurationComplete message to the target cell after successfully performing a random access to the target cell.

In step 8-23, upon recognizing that the mobile IAB node has successfully accessed the target donor through the target cell, the target donor node may inform the source that the mobile IAB node has successfully accessed the target donor. The target donor node may request context information of a DU of the mobile IAB node and may reallocate this information to the target donor node. F1 may be additionally requested, and when it is intended to newly establish an F1 interface with respect to the DU of the mobile IAB node, an F1 interface configuration with respect to the mobile IAB node may be updated based on corresponding F1 configuration information.

In step 8-25, the target donor may request for updating of a configuration of a co-located DU of the mobile IAB node, based on the DU configuration information received in step 8-23. In this case, an F1-AP message may be used for the request, and an indicator indicating to start a new cell (cell 2) to which a factor related to the target donor in a logical DU may be included in the F1-AP message. PCI and/or NCGI information may be included as the factor related to the target donor. An indicator regarding whether to use a hard split physical resource or to use a shared physical resource when operating a new cell may be included.

In step 8-27, the mobile IAB node may start/operate cell 2 by applying the received cell information. In this case, the PCI/NCGI information received from the target node may be broadcast. A cell may operate according to a physical resource operation scheme given in step 8-25. In this case, cell 1 used in the exiting source donor may be operating without alteration.

In step 8-29, the target donor may deliver a DU update complete message to the target node when the DU has successfully turned on cell 2.

In step 8-31, upon starting to operate cell 2, the mobile IAB node may deliver, for each UE, delayed RRCReconfiguration for each access UE, received in step 8-17. In this case, since the UEs are in a state of accessing cell 1, the UEs deliver an RRCReconfiguration message through cell 1. In this case, the mobile IAB node may distribute a timing of delivering the RRCReconfiguration, for each UE. The RRCReconfiguration may be delivered to the UE sequentially with an interval of a specific timing, or the RRCReconfiguration may be delivered to the UE sequentially with an interval of any value within a specific range. Specific range value information may be delivered by the target donor to the source donor in step 8-15, and then may be delivered by the source donor to the mobile IAB node in step 8-17.

In step 8-33, upon receiving the delayed RRCReconfiguration through cell 1, the received RRCReconfiguation configuration is applied for each UE, and the RRCReconfigurationComplete message is delivered to a lower layer. In addition, optionally, a random access to the target cell included in the RRCReconfiguration message may be performed.

In step 8-35, when the UE succeeds in the random access, the target cell may transmit a complete message in the lower layer through cell 2.

In step 8-37, the DU of the mobile IAB node may receive the complete message through cell 2, and may recognize that a corresponding access UE succeeds in a handover.

In step 8-39, the mobile IAB node may deliver the complete message received in step 8-37 to the target donor by containing the message in a ULRRCmsgTransfer which is an F1-AP message. A CU of the target donor may identify that the access UE sends the complete message through cell 2.

In step 8-41, if all the access UEs send the complete message through cell 2, it may be regarded that all the access UEs are coupled to the target donor node.

In step 8-43, upon recognizing that all access UEs which have sent the HO command transmit the complete message through cell 2, through the received RRCReconfiguationComplete message, the target donor node may instruct the mobile IAB node to stop or interrupt an operation of cell 1 used in the source donor. The F1-AP message may be used when this instruction is delivered by including a corresponding indicator.

In step 8-45, the mobile IAB node which has received the message transmitted in step 8-43 may allow the mobile IAB node to turn off cell 1 used in the source node.

In step 8-47, upon completing the turning off the cell of the DU, the DU of the IAB node may notify the target donor that cell 1 has been successfully turned off through a DU configuration update complete message. A corresponding indicator may be included in the message.

If a PCI value of a cell to be used in the target donor is equal to a PCI value of a cell used in the source donor, an operation of operating an additional new cell may be omitted. In this case, not the HO command but the RRCReconfiguration in which a reconfigurationWithSync field is not included may be created from the target node and may be delivered to the access UE. In this case, the RRCReconfiguation for the access UE, created in step 8-13, is delivered to the source donor through step 8-15, and is delivered to the mobile IAB node through step 8-17. In step 8-17, the F1AP message including RRCReconfiguration may not have a delayed RRCReconfiguration indicator. The mobile IAB node which has received this message may deliver a normal RRCReconfiguration message to the UE without delay according to a scheduling of the mobile IAB node.

In case of normal or delayed RRCReconfiguration received in step 8-17, RACH-less HO may be instructed. That is, target cell information may be included in the RRCReconfiguration message, and a time/frequency location of a UL grant resource may be included in advance in a corresponding cell. Optionally, timing advance information to be newly applied may be included. The access UE which has received this information may apply only RRCReconfiguration without the RACH operation, and may transmit a complete message through a previously given UL grant of the target cell and through UL transmission considering a previously given TA.

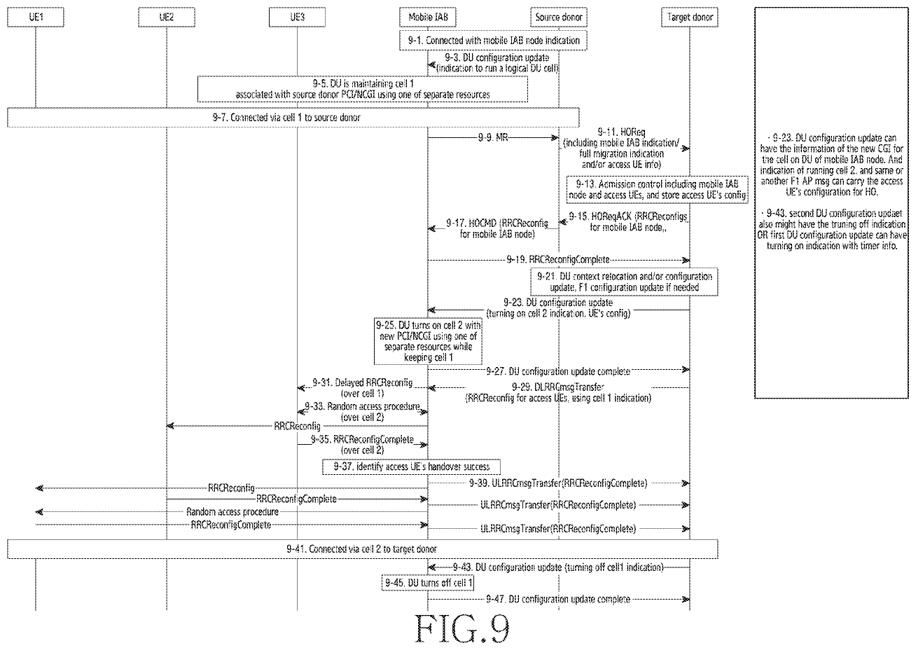

FIG. 9 illustrates an operation of performing a handover of a UE when a target donor is able to store a HO command message of an access UE according to an embodiment.

Descriptions of the same steps as in FIG. 8 will be omitted.

Referring to FIG. 9, in step 9-13, the target donor may not transmit configuration information of a target cell for the access UE to a source node and a mobile IAB node but may store this information in a target donor node until a specific timing.

In step 9-15, the target donor may also deliver a HOReqAck message to the source donor node by including only RRC configuration information in the target cell of the mobile IAB node.

In step 9-17, the source node may deliver a HO command for the mobile IAB node to the mobile IAB node.

In step 9-19, the mobile IAB node may apply the received handover command to perform a random access by considering a cell operated in a parent node or donor DU operated in the target donor node as a target cell, and may deliver an RRCReconfiguationComplete message.

In step 9-29, the target donor node may recognize that a new cell has turned on, and may deliver the handover command (RRCReconfiguration) targeting a new cell to the access UE. In this case, an F1-AP message, i.e., a DLRRCmsgTransfer message, may be used. This message may include the RRCReconfiguration message, and may also include an indicator indicating to deliver a corresponding RRCReconfig message through a cell used in cell 1, i.e., the source donor, or a Boolean indicator of the donor/target cell.

In step 9-31, when the mobile IAB node receives the message of step 9-29, the received RRCReconfiguration may be transmitted to a corresponding access UE through a cell used in cell 1.

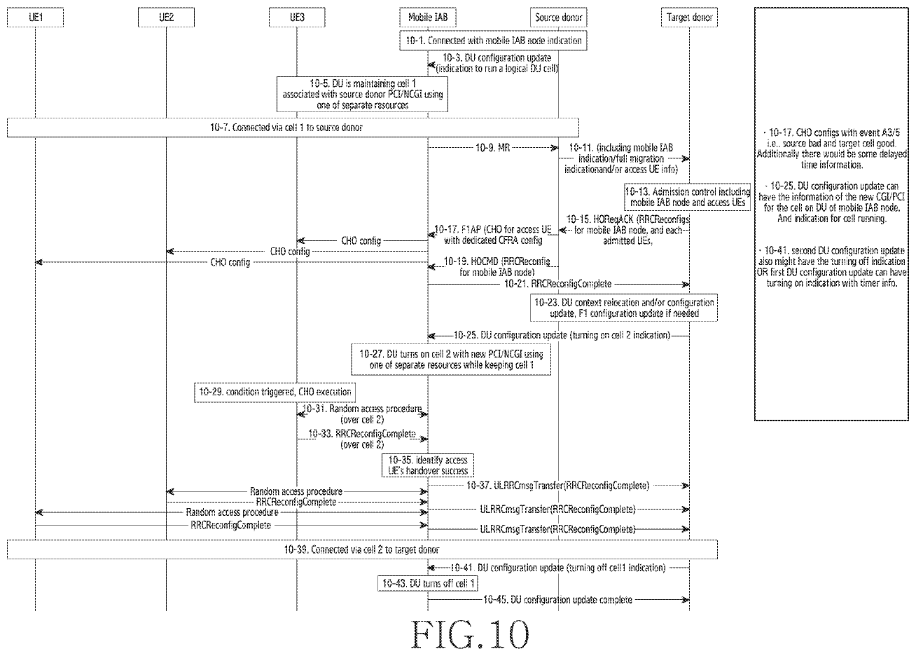

FIG. 10 illustrates an operation of performing a handover of a UE when a conditional handover is applied to an access UE according to an embodiment.

Descriptions of the same steps as in FIG. 8 will be omitted.

Referring to FIG. 10, in step 10-11, a source donor may determine a handover to a target donor, based on a measurement report request. Accordingly, the source donor may send a HandoverRequest message (hereinafter, referred to as HOReq) to the target donor. The HOReq message may include an indicator of a mobile IAB node and/or an indicator indicating full migration. As context information of a migration IAB node, RRC configuration information of an MT currently operating, DU configuration information, information on the number of DRB s/ERABs/BH RLC CHs to be operated, id information of each BH RLC CH, and/or information on the number of DRBs/ERABs/BH RLC CHs desired to operate in the target donor may be included. In addition, as UE context of UEs currently accessing the migrating IAB node, the HOReq message may include RRC configuration information currently operating, DRB/ERAB information, and information on the number of DRB s/ERABs desired to operate in a target. In case of an access UE, an indicator indicating that it is an access UE of the mobile IAB node may be included. The PCI and/or the NCGI, and factor information of the currently operating cell, including whether the hard split resource is used or whether the shared resource is used, may be included in information of the DU. The source node may additionally include an indicator which requests a conditional configuration for the access UE.

In step 10-13, upon receiving the HOReq message of step 10-11, the target node may perform an admission control, and may create configuration information to be used in a target cell to be used by a corresponding admitted IAB node, i.e., a cell operated by a parent node or donor DU controlled by a target donor node. In addition, an admitted access UE may create configuration information to be used in a target cell (named a cell 2 at a later time) being operated by the target donor. In addition, when the conditional configuration indicator is included, the configuration information of the access UEs included in the HOReq message may be recognized as the conditional handover message and created as the conditional handover message.

In step 10-17, the source node delivers the normal RRCReconfiguration message for each access UE to the mobile IAB node, instead of the delay RRCReconfiguration. In this case, an FLAP message is used. The mobile IAB node which has received the RRCReconfiguration message delivers a conditional handover message to each access UE according to a schedule of the mobile IAB node without delay, through cell 1.

Step 10-19 is the same as step 8-19 of FIG. 8. However, step 10-19 is performed prior to step 10-17.

In step 10-29, after the new cell turns on, a conditional handover (CHO) condition of each of the access UEs may be satisfied.

The conditional handover command message may include time information instructing to perform a HO when a specific time elapses after a condition is satisfied for each of the access UEs. The target node may allow this information to be included in the conditional handover command in step 10-13. This information may be determined specific time information and may be a random variable within a specific range. Information included in the conditional handover command message may be to give a temporal change for performing the HO in order to prevent all of the access UEs from performing the HO simultaneously after cell 2 turns on. Predetermined time information may be a time unit of system frame number (SFN), radio frame, system frame, or slot, or may be an absolute time unit such as millisec/micro sec/nano sec, or a time unit of symbol level. Alternatively, the predetermined time information may be a combination of the above units but the disclosure is not limited thereto.

Alternatively, when operating the conditional handover, a handover of the UE may be instructed collectively for a conditional handover through an indicator by using system information of common DCI of a physical downlink control channel (PDCCH), instead of performing the existing given measurement event-based handover. In this case, an indicator notifying that the system information or the common DCI of the PDCCH is used for a condition of the conditional handover may be included in configuration information of the conditional handover or the RRCReconfiguration message which delivers the configuration information. Additionally, the configuration information of the conditional handover or the RRCReconfiguration message which includes and delivers the configuration information may include a time value for allowing each handover to be performed when a specific delay time elapses after it is instructed to be performed. In this case, the UE may perform the conditional handover when a given delay time elapses after being instructed to perform the conditional handover. Alternatively, after being instructed to perform the conditional handover, a random access and complete message transmission may be performed when a delay time elapses, while performing the conditional handover. Predetermined time information may be a time unit of SFN, radio frame, system frame, or slot, or may be an absolute time unit such as mili sec/micro sec/nano sec, or a time unit of symbol level. Alternatively, the predetermined time information may be a combination of the above units.

The program may be stored in an attachable storage device capable of accessing the electronic device through a communication network such as the Internet, an Intranet, a LAN, a wide LAN (WLAN), or a storage area network (SAN) or a communication network configured by combining the networks. The storage device may have access to a device for performing an embodiment of the disclosure via an external port. In addition, an additional storage device on a communication network may have access to the device for performing the embodiment.

It is understood that blocks of processing flow diagrams and combinations of the flow diagrams may be performed by computer program instructions.

Since these computer program instructions may be loaded into a processor of a general purpose computer, a special purpose computer, or another programmable data processing apparatus, the instructions, which are performed by a processor of a computer or another programmable data processing apparatus, create a means for performing functions described in the block(s) of the flow diagram. The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufacturing items containing an instruction means for performing the functions described in the block(s) of the flow diagram. The computer program instructions may also be loaded into a computer or another programmable data processing apparatus, and thus, instructions for operating the computer or another programmable data processing apparatus by generating a computer-executed process when a series of operations are performed in the computer or another programmable data processing apparatus may provide operations for performing the functions described in the block(s) of the flow diagram.

In addition, each block may represent part of a module, segment, or code which includes one or more executable instructions for executing specified logical function(s). It should also be noted that in some alternative implementations, functions mentioned in blocks may occur not in an orderly manner. For example, two blocks illustrated successively may be executed substantially concurrently, or may be performed in a reverse order according to corresponding functions.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a mobile integrated access backhaul (IAB) node in a wireless communication system, the method comprising:
receiving, from a target donor node via a source donor node, a first radio resource control (RRC) message for a migration of the mobile IAB node;
receiving, from the target donor node via the source donor node, a second RRC message for a handover of at least one user equipment (UE) connected with a first cell;
performing the migration with the target donor node based on the first RRC message; and
transmitting, to the at least one UE on a second cell different from the first cell, the second RRC message.

2. The method of claim 1, further comprising:
storing the handover command message, in case that the first RRC message includes a delayed RRC reconfiguration indication corresponding to at least one user equipment (UE); and
transmitting, to the at least one UE, the second RRC message in case that handover condition is met based on the delayed RRC reconfiguration indication.

3. The method of claim 2,
wherein the second RRC message is transmitted to the at least one UE, in case that the mobile IAB donor node turns on the second cell operated by the target donor node.

4. The method of claim 1,
wherein the first RRC message is a message that the target donor node responds to a handover request message including a mobile IAB node indication received from the source donor node.

5. A mobile integrated access backhaul (TAB) node in a wireless communication system, the mobile IAB node comprising:
a transceiver, and
a controller coupled with the transceiver and configured to:
receive, from a target donor node via a source donor node, a first radio resource control (RRC) message for a migration of the mobile IAB node,
receive, from the target donor node via the source donor node, a second RRC message for a handover of at least one user equipment (UE) connected with a first cell,
perform the migration with the target donor node based on the first RRC message, and
transmit, to the at least one UE on a second cell different from the first cell, the second RRC message.

6. The mobile IAB node of claim 5, wherein the controller further configured to:
store the handover command message, in case that the first RRC message includes a delayed RRC reconfiguration indication corresponding to at least one user equipment (UE), and
transmit, to the at least one UE, the second RRC message in case that handover condition is met based on the delayed RRC reconfiguration indication.

7. The mobile IAB node of claim 6,
wherein the second RRC message is transmitted to the at least one UE, in case that the mobile IAB donor node turns on the second cell operated by the target donor node.

8. The mobile IAB node of claim 5,
wherein the first RRC message is a message that the target donor node responds to a handover request message including a mobile IAB node indication received from the source donor node.

9. A method performed by a target donor node in a wireless communication system, the method comprising:
receiving, from a source donor node, a handover request message including a mobile integrated access backhaul (IAB) node indication;
transmitting, to the mobile IAB node via the source donor node, a first radio resource control (RRC) message for a migration of the mobile IAB node; and
transmitting, to the mobile IAB node via the source donor node, a second RRC message for a handover of at least one user equipment (UE) connected with a first cell.

10. The method of claim 9,
wherein the first RRC message includes a delayed RRC reconfiguration indication corresponding to at least one UE.

11. The method of claim 10,
wherein the second RRC message is transmitted from the mobile IAB node to the at least one UE, in case that the mobile IAB donor node turns on the second cell operated by the target donor node.

12. The method of claim 9, further comprising:
receiving, from the mobile IAB node, a third RRC message indicating success for a random access to the second cell; and
transmitting, to the mobile IAB node, a fourth RRC message including a second cell indication used for the mobile IAB node in the second cell.

13. A target donor node in a wireless communication system, the target donor node comprising:
a transceiver, and
a controller coupled with the transceiver and configured to:
receive, from a source donor node, a handover request message including a mobile integrated access backhaul (IAB) node indication,
transmit, to the mobile IAB node via the source donor node, a first radio resource control (RRC) message for a migration of the mobile IAB node, and
transmit, to the mobile IAB node via the source donor node, a second RRC message for a handover of at least one user equipment (UE) connected with a first cell.

14. The target donor node of claim 13,
wherein the first RRC message includes a delayed RRC reconfiguration indication corresponding to at least one UE, and
wherein the second RRC message is transmitted from the mobile IAB node to the at least one UE, in case that the mobile IAB donor node turns on the second cell operated by the target donor node.

15. The target donor node of claim 13, wherein the controller further configured to:
receive, from the mobile IAB node, a third RRC message indicating success for a random access to the second cell, and
transmit, to the mobile IAB node, a fourth RRC message including a second cell indication used for the mobile IAB node in the second cell.
